(19) United States
(12) Patent Application Publication
(10) Pub. No.: US 2002/0108483 A1
(43) Pub. Date: Aug. 15, 2002

(54) Textured pick for a stringed instrument

(76) Inventor: Patricia Wain Smith, Surfside Beach, SC (US)

Correspondence Address: KATHLEEN M HARLESTON, THE HARLESTON LAW FIRM, 909 TALL PINE ROAD, MT PLEASANT, SC, 29464

(21) Appl. No.: 09/784,523

(22) Filed: Feb. 15, 2001

(51) Int. Cl. G10D 3/16

(52) U.S. Cl. 84/322

(57) ABSTRACT

A comfortable, easily gripped pick for a stringed instrument includes: (a) an upper, wider portion comprising an overlay of a textured material, the textured material being adhered to the pick and being no thicker than between about ½ and six times the thickness of the pick, the textured portion covering between about ¼ and ½ of the front and/or rear surface of the pick; and (b) a lower, narrower portion of the pick that does not comprise an overlay.

### BACKGROUND OF THE INVENTION

1. Technical Field

The present device is an easily gripped pick used by a player of a stringed instrument to pick or strum the string or strings of the instrument; more particularly, a pick with a textured upper portion to provide the player with a comfortable, secure and consistent grip, and substantially reduce or eliminate pick rotation, slippage, and resulting distractions and disruption of play.

2. Background Information

Picks for guitars and other stringed instruments are generally made of a smooth, thin plastic or similar material. A user holds the pick between the thumb and forefinger as he or she uses the narrow end of the pick to strum or pick the strings of a guitar or other stringed instrument, such as a mandolin, banjo, or ukulele. In general, the user creates a note by picking a particular string, and a sound by strumming several strings at once. A pick is often used on steel string guitars, including electric guitars, acoustic guitars, and folk guitars, and is also occasionally used on nylon string guitars, such as classical guitars.

Unfortunately, the thin plastic pick material that is useful for producing these desirable sounds is slick and the pick often slips and rotates out of proper position in the musician's fingers. Since the strings must be struck with the narrow end of the pick, the pick must frequently be readjusted in the guitarist's (or other musician's) fingers. This is a common distraction among guitarists. Over time, the musician's fingers perspire and the perspiration contributes to the problem. Maintaining the pick in its proper position becomes a challenge for the guitarist. On occasion, the pick slips and the musician drops it, which interrupts the performance. Mentally, the guitarist is frequently preoccupied with keeping the pick secure. A guitarist may experience unnecessary stress to the fingers from exaggerated finger grasping, which can lead to premature physical and mental fatigue. Although players of all proficiency levels experience these problems, they are particularly troublesome for the beginner.

The present invention is a textured guitar pick that provides a consistently secure, comfortable grip, and does not interfere with sound quality. The textured surface provides a firm, stress-free grip. Although very soft, the texturing provides enough friction to ensure a good grip. The pick of the present invention is designed so that it does not rotate or slip, and is easily held by the fingers during play. Only minimal finger pressure is needed to hold the present grip, and finger stress and fatigue are minimized. The texturing also keeps excess perspiration from the guitarists fingers away from the grip area. Finally, this nonslip guitar pick produces consistently high sound quality.

### BRIEF SUMMARY OF THE INVENTION

The present invention is a guitar pick, which is comfortably and easily gripped, the pick comprising:

an upper, wider portion comprising an overlay of a textured material, the textured material being adhered to the pick and being no thicker than between ½ and six times the thickness of the pick, the textured portion covering between about ½ and ¼ of the front or rear surface of the pick; and

a lower, narrower portion of the pick that does not comprise an overlay.

### BRIEF DESCRIPTION OF THE SEVERAL VIEWS OF THE DRAWINGS

A more complete understanding of the invention and its advantages will be apparent from the following detailed description taken in conjunction with the accompanying drawings, wherein examples of the invention are shown, and wherein:

FIG. 1 is a front elevational view of a pick according to the present invention;

FIG. 2 is a side elevational view of a pick according to FIG. 1;

FIG. 3 is an exploded side elevational view of a pick according to the present invention;

FIG. 4 is an exploded front elevational view of a pick according to the present invention;

FIG. 5 is a front elevational view of a second, alternate embodiment of a pick according to the present invention;

FIG. 6 is a rear elevational view of a third, alternate embodiment of a pick according to the present invention;

FIG. 7 is a rear elevational view of a fourth, alternate embodiment of a pick according to the present invention; and

FIG. 8 is a front elevational view of a fifth, alternate embodiment of a pick according to the present invention.

### DETAILED DESCRIPTION OF THE INVENTION

In the following description, like reference characters designate like or corresponding parts throughout the several views. Also, in the following description, it is to be understood that such terms as “front,” “rear,” and the like are words of convenience and are not to be construed as limiting terms. Referring in more detail to the drawings, the invention will now be described.

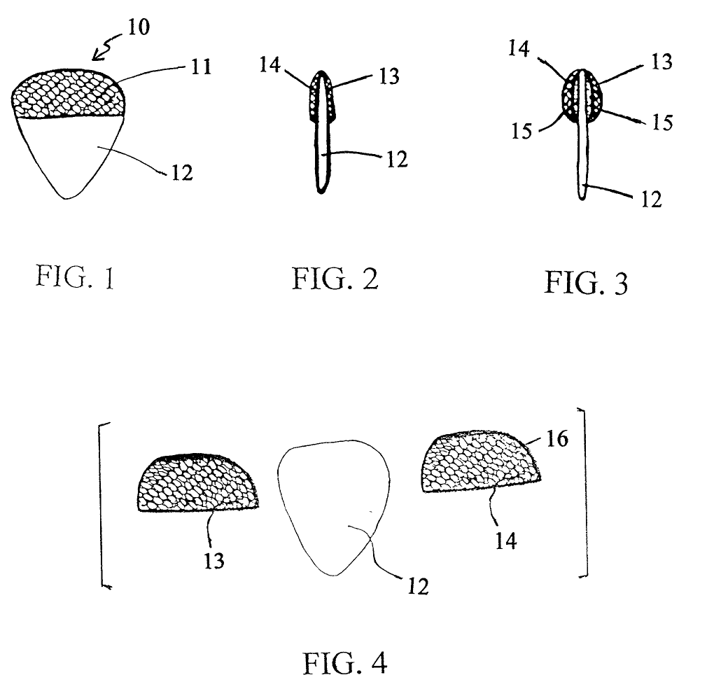

Turning first to FIG. 1, a textured pick, generally referred to as 10, for a stringed instrument comprises: (a) an upper, wider portion 11 comprising an overlay of a textured material, the textured material being adhered to the pick and being no thicker than between about ½ and six times the thickness of the pick, most preferably one to two times. The textured material covers between about ½ and ¼, most preferably about ⅓, of the front and/or rear surface of the pick. The pick 10 further comprises: (b) a lower, narrower portion 12 of the pick that does not comprise an overlay. The texturing provides enough friction to ensure that the pick 10 will not slip easily and is comfortable to grasp. This allows for less stress on the musician, and longer play time. This is especially desirable because many guitarists and other musicians practice daily for hours at a time. Having textured material on the upper portion 11 makes that portion softer, and therefore easier to hold for longer periods. In addition to cushioning the gripping finger and thumb, and substantially eliminating slippage and rotation, the textured material also helps to keep perspiration from the fingers away from the upper portion, or finger area. Even though a pick is a small object, the player's forefinger and thumb are in intimate contact with it for hours during play. A musician would much rather think about the music than the position of the pick.

Picks according to the present invention are generally triangular or teardrop in shape, with curved edges. The musician's fingers generally grip the upper ½ to ⅓ of a pick, so the upper textured portion 11 extends far enough down the pick to furnish a good grip, but not so far that the textured material interferes with the guitar's sound as the guitar is picked or strummed. The lower portion 12 of the pick 10 is conventional plastic pick material.

Referring to FIGS. 2 and 4, a preferred embodiment of the pick 10 has both front and rear sections 13, 14, respectively, of textured material, which each extend across the upper ⅓ to ½, approximately, of the upper portion 11 of the pick. The front and rear of the pick 10 are preferably identical in appearance. The ridges and grooves forming these textures are shallow, so as to assist the grip but not annoy the user over time.

As shown in FIG. 3, the front and rear textured sections 13, 14 are preferably permanently adhered to the front and rear of the pick, respectively, using a suitable adhesive 15, or synthetic adhesive cement. FIG. 3 is shown in exploded view for purposes of illustration, as is FIG. 4. The textured material may alternatively extend around the edges of the pick between the front and rear textured sections 13, 14 of the pick.

The textured material preferably comprises synthetic or naturally occurring rubber, or a rubber-containing or rubber-like polymer material, including foam rubber. Rubber is any solid substance that upon vulcanization becomes elastic. Rubber is a particularly good material for use herein because, among other things, it is soft, flexible, lightweight, and inexpensive. It is impermeable and water-repellent and therefore unchanged by sweat or pressure from the fingers. It requires only a small amount of adhesive to adhere it to the pick because of its inherent adhesiveness. It provides a consistently secure, comfortable grip on the pick and substantially eliminates pick slippage and rotation. It is durable and keeps its shape and texture even after being pressed for hours between the fingers. In the end, though, the great majority of musicians would not use a pick for comfort if it interfered with the quality of sound produced by the pick. The present invention does not interfere with the high quality sound that the pick is capable of producing.

Many players store their picks between the strings at the top of the fingerboard. Harmful residues, sticky adhesives, or scratchy abrasives (such as sandpaper) on the surface of the pick could damage the wood or other elements of the instrument in that area of the instrument over time. Also, some people have skin that is sensitive to such chemicals or abrasives. Adhesives and chemicals can also leave annoying residues on the fingertips after use. The textured rubber material preferred for use herein is non-irritating even to those with sensitive skin, does not leave a residue on the fingertips, and will not damage the instrument.

In the preferred embodiment shown in FIGS. 1-4, the front or rear textured section 13, 14 more preferably measures between about 0.05 and about 0.3 centimeter, most preferably about 0.1 centimeter (1/32 inch), in thickness. The front or rear textured section 13, 14 is more preferably between about 0.75 and about 1.5 centimeters, most preferably about 1.0 centimeter, in length. The front or rear textured section 13, 14 thus most preferably covers about ⅓ of the length of a pick that is three centimeters in length, measuring from the approximate center of the edge of the upper portion 11 to the apex of the narrow lower portion 12 of the pick. The textured material extends across the width of the upper portion of the pick, which is about 2.7 centimeters in the preferred embodiment, from edge to edge. On a three centimeter long pick, then, the textured section 13 or 14 most preferably extends about a third of the way down the pick, starting at the edge. The front and rear of the pick are preferably identical to one another.

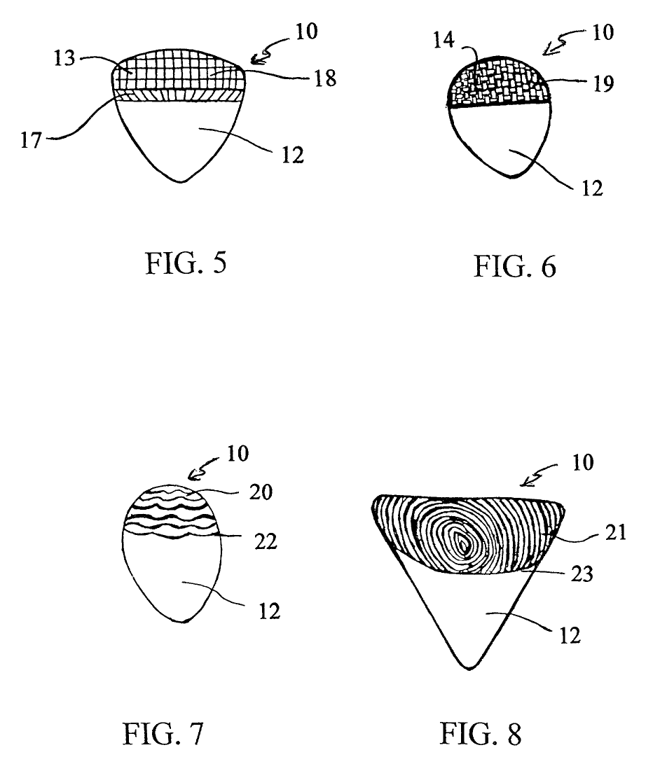

Referring to the alternate embodiment shown in FIG. 5, the lower edge of the front and rear textured sections 13, 14 comprise a narrow lower border 17 that is sloped toward the lower portion 12 of the pick 10, so that the transition area between the textured material and the smooth lower portion is smooth to the touch. The upper textured portion in FIG. 5 includes crisscrossed lines 18, which are believed to keep excess perspiration away from the fingertips, so the pick is easier to hold without slipping.

Referring to FIGS. 4-8, several alternate textures in the textured material are preferred herein. Importantly, the texturizing is on the surface of the textured material, so that it is part of the material. The exterior of the upper textured portion preferably does not comprise adhesive, which is uncomfortable to touch and leaves a sticky residue on the fingertips after play. Also, the exterior of the upper textured surface preferably does not comprise an abrasive material. In fact, there are preferably no top layers added or distributed on the upper surface of the textured material. The shallow grooves are formed into the material itself. Generally, it has been found that a plurality of shallow lines, rather than a few deep lines, correlate with a better, more comfortable grip. A plurality of grooves and ridges are formed into the textured material used herein. This is not the equivalent of one or two indentations in the pick for detecting the position of the pick with a fingertip.

Continuing with FIGS. 4 through 8, the upper textured portion 11 is preferably: dimpled 16, as shown in FIG. 4; a series of crisscrossed lines 18, as shown in FIG. 5; interwoven rows 19, as shown in FIG. 6; a series of generally parallel waved lines 20, as shown in FIG. 7; or a series of generally concentric circles, similar to a partial fingerprint 21, as shown in FIG. 8. The textured material may also comprise a series of zigzags, swirls or curves. These textures work particularly well because they conform to the natural curves of the fingers. The ridges and grooves forming these textures are shallow, so as to assist the grip but not annoy the user over time. By “shallow” is meant between about 0.001 millimeter and about 0.2 centimeter deep (i.e., the height of the ridges), most preferably between about 0.1 millimeter and about 0.1 centimeter deep. Without meaning to be bound by theory, it is believed that these textures, and this groove depth, allow a better, more comfortable grip on the pick 10 over time. In most people, fingertips are well-enervated and the skin there is quite sensitive. Even though they facilitate gripping the pick, these textures are more gentle on the player's fingertips over the long periods of time that many musicians spend playing their instrument.

In the alternate embodiments shown in FIGS. 7 and 8, the lower edge of the textured material 11 is curved. The lower edge of the upper textured portion 11 is scalloped 22 in FIG. 7, and curved upward 23 in FIG. 8. These curved lower edges are preferred by some players as feeling more natural over time, versus a straight edge. FIGS. 7 and 8 also show variations in the shape of the pick 10. Any of the above-described embodiments may have a lower edge 17 on the upper textured portion 11 which gradually inclines toward the lower portion 12 of the pick. This is believed to form a closer seal between the textured material and the pick material, so that the pick 10 will be even longer lasting.

From the foregoing it can be realized that the described device of the present invention may be easily and conveniently utilized as a grippable pick for a stringed instrument. It is to be understood that any dimensions given herein are illustrative, and are not meant to be limiting.

While preferred embodiments of the invention have been described using specific terms, this description is for illustrative purposes only. It will be apparent to those of ordinary skill in the art that various modifications, substitutions, omissions, and changes may be made without departing from the spirit or scope of the invention, and that such are intended to be within the scope of the present invention as defined by the following claims. It is intended that the doctrine of equivalents be relied upon to determine the fair scope of these claims in connection with any other person's product which fall outside the literal wording of these claims, but which in reality do not materially depart from this invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

### BRIEF LIST OF REFERENCE NUMBERS USED IN THE DRAWINGS

(For Information Only)

10 pick

11 upper textured portion

12 lower, smooth portion

13 front textured section

14 rear textured section

15 adhesive

16 dimpled upper portion

17 lower border of upper textured portion

18 crisscrossed upper textured portion

19 woven upper textured portion

20 waves

21 partial fingerprint

22 scalloped lower edge

23 curved lower edge

What is claimed is:

1. A comfortable, easily gripped pick for a stringed instrument, the pick comprising:
an upper, wider portion comprising an overlay of a textured material, the textured material being adhered to the pick and being no thicker than between about ½ and six times the thickness of the pick, the textured portion covering between about ¼ and ½ of the front or rear surface of the pick; and
a lower, narrower portion of the pick that does not comprise an overlay.

2. A pick according to claim 1, wherein the textured material comprises natural or synthetic rubber.

3. A pick according to claim 2, further comprising a layer of adhesive or synthetic adhesive cement between the front and rear textured sections and the pick.

4. A pick according to claim 2, wherein the lower edge of the upper textured portion is gradually inclined toward the lower portion of the pick.

5. A pick according to claim 2, wherein the exterior of the upper textured portion does not comprise adhesive.

6. A pick according to claim 5, wherein the front textured section covers about ⅓ of the front surface of the pick, and the rear textured section covers about ⅓ of the rear surface of the pick.

7. A pick according to claim 6, wherein the textured material does not extend around the edges of the pick between the front and rear textured sections of the pick.

8. A pick according to claim 2, wherein the texturizing on the textured material comprises grooves between about 0.001 millimeter and 0.2 centimeter deep, the grooves being formed into the surface of the textured material.

9. A pick according to claim 8, wherein the exterior of the upper textured surface does not comprise an abrasive material.

10. A pick according to claim 9, wherein the upper textured portion comprises dimpled texturing.

11. A pick according to claim 9, wherein the upper textured portion comprises crisscrossed lines.

12. A pick according to claim 9, wherein the upper textured portion comprises a lower border that is sloped toward the lower portion of the pick.

13. A pick according to claim 2, wherein the upper textured portion comprises a plurality of ridges and grooves in the shape of a partial fingerprint.

14. A pick according to claim 13, wherein the upper textured portion comprises a lower edge that is curved.

15. A pick according to claim 2, wherein the upper textured portion comprises a series of generally parallel waved lines.

16. A pick according to claim 15, wherein the textured material extends around the edges of the pick between the front and rear textured sections of the pick.

17. A pick according to claim 15, wherein the upper textured portion comprises a lower edge that is scalloped.

18. A pick according to claim 17, wherein the upper textured portion comprises interwoven rows.
